(19) United States
(12) Patent Application Publication
(10) Pub. No.: US 2014/0305205 A1
(43) Pub. Date: Oct. 16, 2014

(54) SELF-OSCILLATION CIRCUIT AND METHOD THEREOF

(71) Applicant: SAMSUNG ELECTRO-MECHANICS CO., LTD., Suwon-si (KR)

(72) Inventor: Chang Hyun KIM, Suwon-si (KR)

(73) Assignee: SAMSUNG ELECTRO-MECHANICS CO., LTD., Suwon-si (KR)

(21) Appl. No.: 14/056,812

(22) Filed: Oct. 17, 2013

(30) Foreign Application Priority Data
Apr. 12, 2013 (KR) 10-2013-0040330

(51) Int. Cl. G01C 19/56

(52) U.S. Cl. CPC G01C 19/56
USPC 73/504.12

(57) ABSTRACT

Disclosed herein are a self-oscillation circuit and a method thereof.

The self-oscillation circuit includes: a gyroscope sensor receiving a driving signal at its input terminal to resonate with and output it; a sensor driver outputting the driving signal for driving the gyroscope sensor; a phase shifter receiving a signal from the gyroscope sensor and shifting a phase of the received signal; and a time delay unit receiving the shifted signal from the phase shifter and delaying it for a predetermined time period, and then feeding the delayed signal back to the sensor driver.

### CROSS REFERENCE(S) TO RELATED APPLICATIONS

This application claims the benefit under 35 U.S.C. Section 119 of Korean Patent Application Serial No. 10-2013-0040330, entitled “Self-Oscillation Circuit and Method Thereof” filed on Apr. 12, 2013, which is hereby incorporated by reference in its entirety into this application.

### BACKGROUND OF THE INVENTION

1. Technical Field

The present invention relates to a self-oscillation circuit and a method thereof, and more particularly, to a self-oscillation which is capable of improving the sensitivity of a gyroscope sensor by changing the driving frequency of the gyroscope sensor using a circuit so that it resonates around a sensed signal circuit, and a method thereof.

2. Description of the Related Art

A gyroscope is a device for measuring an angular velocity using the Coriolis force of a vibrating object. The Coriolis force is represented by the following equation:

F=2 mVΩ [Equation 1]

Wherein, F denotes the Coriolis force, m denotes mass, V denotes velocity, and Ω denotes angular velocity.

The angular velocity Ω is represented by Ω=F/2 mV, and when a constant velocity V is applied to an object, Ω may be calculated by measuring F. In order for an object to obtain a constant velocity V, a vibrating-structure gyroscope uses a feedback system that self-oscillates. The system self-oscillates when the phase of the feedback loop is 180°, and the open loop gain is 1 or greater. When a driving signal of the resonant frequency is applied to a gyroscope sensor, a signal output from the gyroscope sensor has a phase shifted by 90°. Therefore, in order for the gyroscope sensor to self-oscillate, a phase shifter is used to shift the phase by 90°, and thus a total of 180° is shifted, such that the gyroscope sensor self-oscillates. When the frequencies of the driving shaft and the signal sensing shaft of the gyroscope sensor are separated by 1 kHz or more, there is approximately a 90° phase difference therebetween, such that it is possible to restore a signal sensed by the gyroscope sensor using an appropriate phase shifter for a driving signal.

However, depending on the frequency differences between the driving shaft and the sensing shaft, attenuation in the sensed signal occurs, such that the overall sensitivity of the gyroscope sensor is degraded. That is, as shown in FIGS. 1A and 1B, the closer the resonant frequency of the driving part and the resonant frequency of the sensing part are (the resonant frequencies are closer to each other in FIG. 1B than in FIG. 1A), or the gyroscope sensor resonates with a resonant frequency closer to the resonant frequency of the sensing part, the amplitude of the sensed signal becomes larger. In order to develop a gyroscope sensor with a higher sensitivity, it is required to approximate the driving frequency to the sensing frequency. However, the resonant frequency of the gyroscope sensor is difficult to be precisely controlled due to the deviations in different manufacturing processes of the gyroscope sensor, such that errors are likely to occur. In order to reduce such errors in the resonant frequency, precise processes are required, resulting in increases in manufacturing cost.

### RELATED ART DOCUMENTS

### Patent Documents

(Patent Document 1) Japanese Patent Laid-Open Publication No. 2008-241330

(Patent Document 2) US Patent Laid-Open Publication No. 2010-0206074

### SUMMARY OF THE INVENTION

An object of the present invention is to provide a self-oscillation circuit which is capable of improving the sensitivity of a sensor by changing a driving frequency of the sensor so that it resonates around a sensed signal using a circuit, instead of costly precise processes, and a method thereof.

According to an exemplary embodiment of the present invention, there is provided a self-oscillation circuit, including: a gyroscope sensor receiving a driving signal at its input terminal, resonating with the driving signal, and outputting the resonated signal; a sensor driver outputting the driving signal for driving the gyroscope sensor; a phase shifter receiving a signal from the gyroscope sensor and shifting a phase of the received signal; and a time delay unit disposed between the phase shifter and the sensor driver, and receiving the shifted signal from the phase shifter and delaying it for a predetermined time period, and then feeding the delayed signal back to the sensor driver.

The signal output from the gyroscope sensor may be in current form.

The circuit may further include a voltage converter receiving the signal in current form from the gyroscope sensor to convert the received signal into a signal in voltage form, so as to provide the converted signal to the phase shifter.

The circuit may further include a demodulator receiving the signal output from the gyroscope sensor and a signal which is output from the phase shifter and delayed by the time delay unit, and demodulating them to a signal originally output from the gyroscope sensor.

The circuit may further include a high-frequency noise filter provided at an output of the demodulator so as to remove high-frequency noise from the signal output from the demodulator.

The time delay unit may consist of a plurality of inverters connected in series.

The circuit may further include an automatic gain controller between the time delay unit and the sensor driver so as to maintain the driving signal output from the sensor driver to a constant amplitude.

The circuit may further include an amplifier provided at an output of the high-frequency noise filter so as to amplify the signal having been through the high-frequency noise filter and outputting the amplified signal.

According to another exemplary embodiment of the present invention, there is provided a self-oscillation method using a gyroscope sensor, a sensor driver, a voltage converter, a phase shifter, a time delay unit and a demodulator, the method including: outputting, by the sensor driver, a signal for driving the gyroscope sensor; receiving, by the gyroscope sensor, the signal from the sensor driver and resonating with the signal to output a signal; receiving, by the phase shifter, the signal from the gyroscope sensor and shifting a phase of the signal; and receiving, by the time delay unit, the phase-shifted signal from the phase shifter, delaying it for a predetermined time period to feed back the delayed signal to the sensor driver.

The signal output from the gyroscope sensor may be in current form.

The method may further include receiving, by a voltage converter, the signal in current form from the gyroscope sensor to convert the received signal into a signal in voltage form, so as to provide the converted signal to the phase shifter.

The method may further include receiving, by a demodulator, the signal output from the gyroscope sensor and a signal which is output from the phase shifter and delayed by the time delay unit, and demodulating them to a signal originally output from the gyroscope sensor.

The method may further include, after the demodulating by the demodulator, removing, by a high-frequency noise filter, high-frequency noise from the signal output from the demodulator.

The method may further include, after the removing of the high-frequency noise by the high-frequency noise filter, amplifying the noise-removed signal by an amplifier to output the amplified signal.

The method may further include receiving, by an automatic gain controller, the time-delayed signal by the time delay unit to maintain the driving signal output from the sensor driver to a constant amplitude.

An overall delayed time of a signal passing through a plurality of (n) inverters connected in series may be determined by multiplying the time taken by a unit inverter by n.

### BRIEF DESCRIPTION OF THE DRAWINGS

FIGS. 1A and 1B are graphs illustrating the changes in amplitude of sensed signals depending on the difference in resonant frequencies between a driving part and a sensing part;

FIG. 2 is a diagram schematically illustrating the configuration of a self-oscillation circuit according to an exemplary embodiment of the present invention;

FIG. 3 is a diagram schematically illustrating the configuration of a time delay unit of the self-oscillation circuit according the exemplary embodiment of the present invention;

FIG. 4 is a diagram schematically illustrating the configuration of a self-oscillation circuit according to another exemplary embodiment of the present invention;

FIG. 5 is a flowchart illustrating the operation process of a self-oscillation method according to an exemplary embodiment of the present invention; and

FIG. 6 is a flowchart illustrating the operation process of a self-oscillation method according to another exemplary embodiment of the present invention.

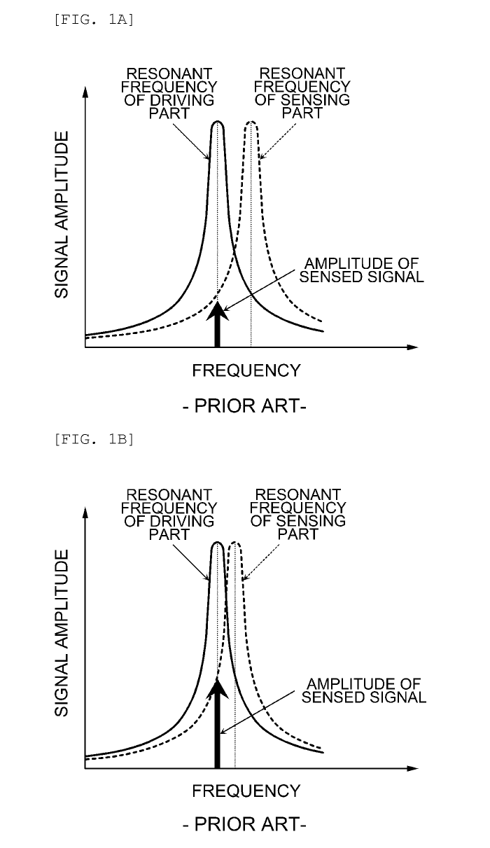

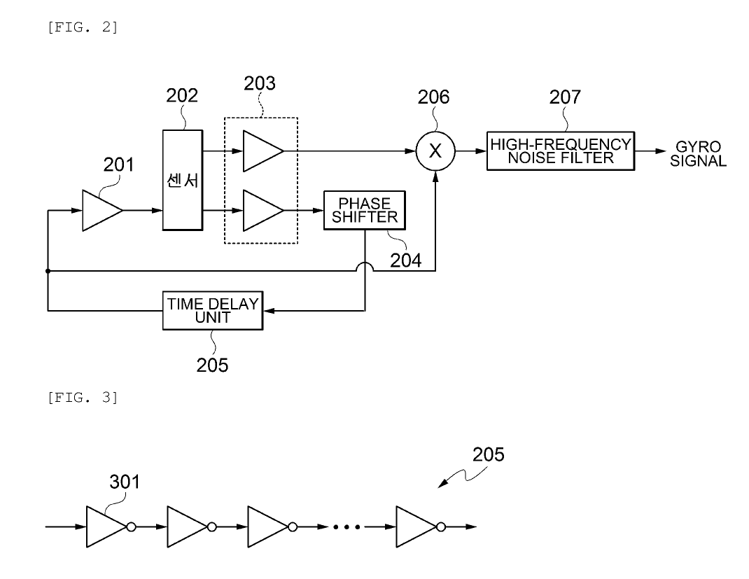

### DESCRIPTION OF THE PREFERRED EMBODIMENTS

Terms and words used in the present specification and claims are not to be construed as a general or dictionary meaning, but are to be construed as meaning and concepts meeting the technical ideas of the present invention based on a principle that the inventors can appropriately define the concepts of terms in order to describe their own inventions in the best mode.

Throughout the present specification, unless explicitly stated otherwise, “comprising” any components will be understood to imply the inclusion of other elements rather than the exclusion of any other elements. A term “part,” “module,” “device,” or the like, described in the specification means a unit of processing at least one function or operation and may be implemented by hardware or software or a combination of hardware and software.

Hereinafter, exemplary embodiments of the present invention will be described in detail with reference to the accompanying drawings.

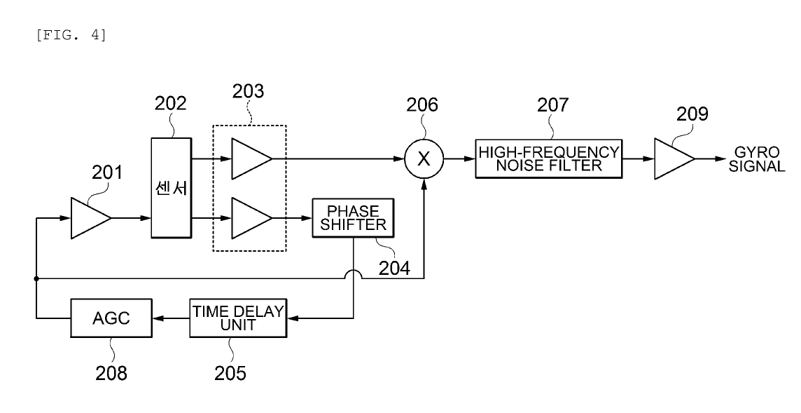

FIG. 2 is a diagram schematically illustrating the configuration of a self-oscillation circuit according to an exemplary embodiment of the present invention.

Referring to FIG. 2, the self-oscillation circuit according to the exemplary embodiment is configured to include a sensor driver 201, a gyroscope sensor 202, a voltage converter 203, a phase shifter 204, a time delay unit 205, and a demodulator 206.

The sensor driver 201 outputs a signal for driving the gyroscope sensor 202.

The gyroscope sensor 202 receives a driving signal output from the sensor driver 201 at its input terminal, resonates with it, and outputs a signal. The gyroscope sensor 202 may output a signal in current form.

The voltage converter 203 may receive the signal in current form from the gyroscope sensor 202 to convert it into a signal in voltage form.

The phase shifter 204 may receive the signal from the gyroscope sensor 202 to shift the phase of the signal. The phase shifter 204 may receive the signal in voltage form from the voltage converter 203 to shift the phase of the signal in voltage form.

The time delay unit 205, which is disposed between the phase shifter 204 and the sensor driver 201, receives the phase-shifted signal in voltage form from the phase shifter 204, delays it for a predetermined time period, and feeds it back to the sensor driver 201. Here, the time delay unit 205 may consist of a plurality of inverters 301 connected in series, as shown in FIG. 3.

The demodulator 206 receives the signal which was output from the gyroscope sensor 202 and then converted into voltage form by the voltage converter 203, and the signal which was output from the phase shifter 204 and then delayed for the predetermined time period by the time delay 205, and demodulates it to a signal originally output from the gyroscope sensor 202. The demodulator 206 may include a multiplier.

Preferably, a high-frequency noise filter 207 for removing high frequency noise from the signal output from the demodulator 206 may be further provided at the output of the demodulator 206. The high-frequency noise filter 207 may include a low pass filter.

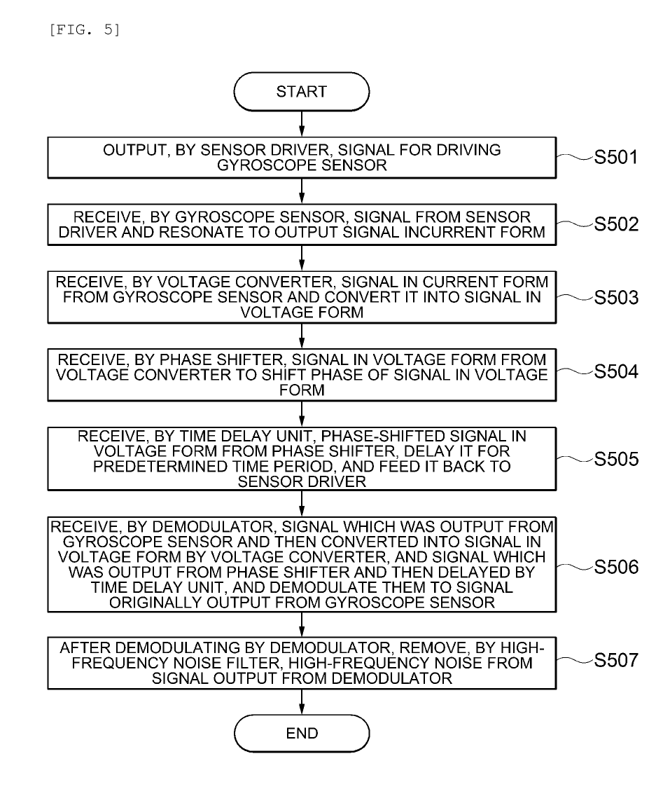

Preferably, as shown in FIG. 4, an automatic gain controller (AGC) 208 may be further provided between the time delay 205 and the sensor driver 201 in order to maintain the driving signal output from the sensor driver 201 to a constant value. In operation, the automatic gain controller 208 receives a signal output from the time delay 205 to perform gain control on it, and provides the sensor driver 201 and the demodulator 206 with the gain-controlled signal.

Preferably, an amplifier 209 may be further provided at the output of the high-frequency noise filter 207 in order to amplify the signal output from the high-frequency noise filter 207 to output the amplified signal.

Now, a self-oscillation method using the self-oscillation circuit according to the exemplary embodiment will be described.

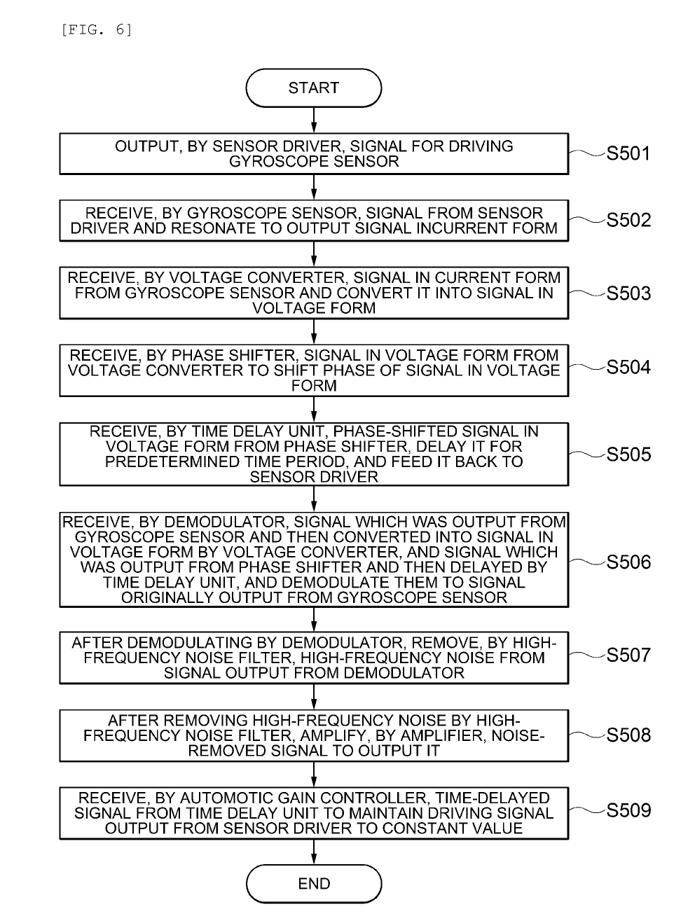

FIG. 5 is a flowchart illustrating the operation process of a self-oscillation method according to an exemplary embodiment of the present invention.

The self-oscillation method according to the exemplary embodiment uses a self oscillation circuit consisting of a sensor driver 201, a gyroscope sensor 202, a voltage converter 203, a phase shifter 204, a time delay unit 205, and a demodulator 206. Referring to FIG. 5, initially, the sensor driver 201 outputs a signal for driving the gyroscope sensor 202 (S501).

Then, the gyroscope sensor 202 receives the signal from the sensor driver 201 and resonates with it to output a signal (S502). The gyroscope sensor 202 may output a signal in current form.

Then, the voltage converter 203 may receive the signal in current form from the gyroscope sensor 202 to convert it into a signal in voltage form (S503).

Then, the phase shifter 204 may receive the signal in voltage form from the voltage converter 203 to shift the phase of the signal in voltage form (S504).

Then, a time delay unit 205 receives the phase-shifted signal in voltage form from the phase shifter 204, delays it for a predetermined time period, and feeds it back to the sensor driver 201 (S505). Here, an overall delayed time of a signal by the time delay unit 205 passing through a plurality of (n) inverters 301 connected in series may be determined by multiplying the time taken by a unit inverter dT by n, i.e., n×dT.

That is, when a signal output from the phase shifter 204 is input to the time delay unit 205, the time delay unit 205 generates a delayed time equal to n×dT for the signal passing through n inverter, where a time passing through a unit inverter 301 of the time delay 205 is dT. That is, the number of n inverters required to lower the resonant frequency to a desired frequency is calculated as described below:

If a target resonant frequency of a gyroscope sensor is denoted as F_target, and the original resonant frequency of the gyroscope sensor is denoted as F_resonant, the following relationship is established:

F_target=1/(1/F_resonant+n×dT)

For example, when the time delay dT of the inverter 301 is 10 nsec, and F_target is 40 kHz and F_resonant is 40.1 kHz, with approximately six inverters, the resonant frequency of the gyroscope sensor 202 may be adjusted to 40 kHz. Accordingly, by varying the number of the inverters 301 depending on the resonant frequency characteristic of the gyroscope sensor 202, the resonant frequency may be set to a desired value.

After the time delay unit 205 receives the phase-shifted signal in voltage form from the phase shifter 204 and delays it for a predetermined time period, the demodulator 206 receives the signal which was output from the gyroscope sensor 202 and then converted into voltage form by the voltage converter 203, and the signal which was output from the phase shifter 204 and then delayed for the predetermined time period by the time delay 205, and demodulates it to a signal originally output from the gyroscope sensor 202 (S506).

By doing so, the self-oscillation method according to the exemplary embodiment is substantially completed, and finally a signal is output from the gyroscope sensor.

More preferably, the method may further include, after demodulating by the demodulator 206, removing high-frequency noise from the signal output from the demodulator 206 by a high-frequency noise filter 207 (S507). With the removing of high-frequency noise (S507), the gyroscope sensor signal may be more reliable since noise therein is removed.

Preferably, as shown in FIG. 6, the method may further include, after removing of the high-frequency noise by the high-frequency noise filter, amplifying the signal from which high-frequency noise are removed to output the amplified signal by an amplifier 209 (shown in FIG. 4) (S508). This is performed in order to obtain a more clear signal when the amplitude of the signal output from the gyroscope sensor 202 is small by amplifying it.

Preferably, the method may further include receiving the signal which was delayed by the time delay unit 205 for a predetermined time period by an automatic gain controller 208 (shown in FIG. 4) to maintain a driving signal output from the sensor driver 201 to a constant value (S509). This may be necessary when the sensor driver 201 may not be able to output a constant signal due to ambient temperature or humidity. Therefore, by receiving the signal output from the time delay unit 205 and performing gain control on it, and by providing the gain-controlled signal to the sensor driver 201 with the automatic gain controller 208, the driving signal output from the sensor driver 201 may be maintained to a constant value.

As described above, the self-oscillation circuit according to the exemplary embodiment may adjust the sensitivity of a signal by providing a time delay in the resonant loop of the gyroscope sensor and precisely adjust the resonant frequency of the gyroscope sensor, such that the yield rate of the gyroscope sensor may be improved. Further, according to the exemplary embodiment, a signal output from the gyroscope sensor can be adjusted, such that the sensitivity of the gyroscope sensor may be improved.

Although the exemplary embodiments of the present invention have been disclosed for illustrative purposes, the present invention is not limited thereto, but those skilled in the art will appreciate that various modifications, additions and substitutions are possible, without departing from the scope and spirit of the invention as disclosed in the accompanying claims. Therefore, the true scope of the present invention to be protected should be defined only by the appended claims and it is apparent to those skilled in the art that technical ideas equivalent thereto are within the scope of the present invention.

What is claimed is:

1. A self-oscillation circuit, comprising:
a gyroscope sensor receiving a driving signal at its input terminal to resonate with and output it;
a sensor driver outputting the driving signal for driving the gyroscope sensor;
a phase shifter receiving a signal from the gyroscope sensor and shifting a phase of the received signal; and
a time delay unit disposed between the phase shifter and the sensor driver, and receiving the shifted signal from the phase shifter and delaying it for a predetermined time period, and then feeding the delayed signal back to the sensor driver.

2. The circuit according to claim 1, wherein the signal output from the gyroscope sensor is in current form.

3. The circuit according to claim 2, further comprising a voltage converter receiving the signal in current form from the gyroscope sensor to convert the received signal into a signal in voltage form, so as to provide the converted signal to the phase shifter.

4. The circuit according to claim 1, further comprising a demodulator receiving the signal output from the gyroscope sensor and a signal which is output from the phase shifter and delayed by the time delay unit, and demodulating them to a signal originally output from the gyroscope sensor.

5. The circuit according to claim 4, further comprising a high-frequency noise filter provided at an output of the demodulator so as to remove high-frequency noise from the signal output from the demodulator.

6. The circuit according to claim 1, wherein the time delay unit consists of a plurality of inverters connected in series.

7. The circuit according to claim 1, further comprising an automatic gain controller between the time delay unit and the sensor driver so as to maintain the driving signal output from the sensor driver to a constant amplitude.

8. The circuit according to claim 5, further comprising an amplifier provided at an output of the high-frequency noise filter so as to amplify the signal having been through the high-frequency noise filter and outputting the amplified signal.

9. A self-oscillation method using a gyroscope sensor, a sensor driver, a voltage converter, a phase shifter, a time delay unit and a demodulator, the method comprising:
outputting, by the sensor driver, a signal for driving the gyroscope sensor;
receiving, by the gyroscope sensor, the signal from the sensor driver and resonating with the signal to output a signal;
receiving, by the phase shifter, the signal from the gyroscope sensor and shifting a phase of the signal; and
receiving, by the time delay unit, the phase-shifted signal from the phase shifter, and delaying it for a predetermined time period to feed back the delayed signal to the sensor driver.

10. The method according to claim 9, wherein the signal output from the gyroscope sensor is in current form.

11. The method according to claim 10, further comprising receiving, by the voltage converter, the signal in current form from the gyroscope sensor to convert the received signal into a signal in voltage form to provide the converted signal to the phase shifter.

12. The method according to claim 9, further comprising receiving, by the demodulator, the signal output from the gyroscope sensor and a signal which is output from the phase shifter and delayed by the time delay unit, so as to demodulate them to a signal originally output from the gyroscope sensor.

13. The method according to claim 12, further comprising, after the demodulating by the demodulator, removing, by a high-frequency noise filter, high-frequency noise from the signal output from the demodulator.

14. The method according to claim 13, further comprising, after the removing of the high-frequency noise by the high-frequency noise filter, amplifying the noise-removed signal by an amplifier to output the amplified signal.

15. The method according to claim 9, further comprising receiving, by an automatic gain controller, the time-delayed signal by the time delay unit to maintain the driving signal output from the sensor driver to a constant amplitude.

16. The method according to claim 9, wherein an overall delayed time of a signal by the time delay unit passing through a plurality of (n) inverters connected in series is determined by multiplying the time taken by a unit inverter by n.
